(19) United States
(12) Patent Application Publication
(10) Pub. No.: US 2007/0158154 A1
(43) Pub. Date: Jul. 12, 2007

(54) Piston assembly with reduced shuttle

(75) Inventors: Richard E. Bluemle, Columbia, SC (US); Walter Douglas Bauman, Wixom, MI (US); Mark M. Rose, Myrtle Beach, SC (US)

Correspondence Address: CARLSON, GASKEY & OLDS, P.C., 400 WEST MAPLE ROAD, SUITE 350, BIRMINGHAM, MI, 48009, US

(73) Assignee: AVM, Inc.

(21) Appl. No.: 11/330,664

(22) Filed: Jan. 12, 2006

(51) Int. Cl. F16F 9/00

(52) U.S. Cl. 188/322.22

(57) ABSTRACT

A piston assembly for a gas spring or damper includes first and second orifice plates that are axially spaced apart from each other. First and second low-friction rings are positioned between the first and second orifice plates. The first and second low-friction rings are separated from each other by a resilient member, which reacts between the first and second low-friction rings to eliminate dead-band operation as the piston assembly moves between extension and compression positions.

### TECHNICAL FIELD

The subject invention relates to piston assembly for a gas spring or damper that includes a resilient member that reduces shuttling of piston components between extension and compression positions.

### BACKGROUND OF THE INVENTION

Gas spring assemblies and dampers are used to control movement of one component relative to another component. A damper or gas spring assembly is used to control movement of a movable vehicle component relative to a fixed vehicle component. The damper or gas spring assembly is moveable between a fully extended position and a fully compressed position. A gas spring assembly assists an operator with movement of the movable vehicle component. A damper is used to dampen input loads to a vehicle chassis.

Gas springs and dampers each include a rod and piston assembly that is received within a cylinder. One rod end is coupled to the piston assembly to move the piston assembly back and forth within the cylinder. An opposite rod end is mounted to one of the movable vehicle component or the fixed vehicle component. The cylinder is mounted to the other of the movable vehicle component or the fixed vehicle component. The piston includes multiple orifice plates that cooperate with washers to restrict fluid flow during compression and extension to dampen or assist movement depending on a desired application.

In one known configuration, the piston assembly comprises a dual dampening piston that includes first and second orifice plates that are separated by a spacer. Located between the first and second orifice plates is an o-ring positioned between first and second washers. When compressed or extended, friction on the o-ring forces one of the first and second washers to move axially against a respective one of the first and second orifice plates depending upon direction of movement. This provides a restrictive flow path in an opposite direction to the direction of movement.

One disadvantage with this traditional configuration is that a dead band of operation occurs as the first and second washers and o-ring shuttle back and forth between the first and second orifice plates. This “slop” reduces the operating efficiency of the piston assembly.

Thus, there is a need for a piston assembly that eliminates slop between internal piston components as the rod moves the piston assembly back and forth between extended and retracted positions.

### SUMMARY OF THE INVENTION

A piston assembly includes first and second orifice plates that are axially spaced apart from each other. First and second rings made from a low-friction material are positioned between the first and second orifice plates. A resilient member reacts between the first and second rings. The piston assembly could be utilized in a gas spring assembly or a damper, each of which includes a cylinder. The piston assembly is mounted within an internal cavity of the cylinder and is connected to a rod. The rod moves the piston assembly back and forth within the cylinder between extension and compression positions.

A biasing force exerted by the resilient member on the first and second rings eliminates dead-band operation as the piston assembly moves between extension and compression. These and other features of the present invention can be best understood from the following specification and drawings, the following of which is a brief description.

### BRIEF DESCRIPTION OF THE DRAWINGS

FIG. 1A shows a schematic view of a piston assembly and rod assembly incorporating the subject invention, where the piston assembly and rod assembly are in a neutral or no load position.

FIG. 1B is a view of the piston assembly and rod assembly in a compression position.

FIG. 1C is a view of the piston assembly and rod assembly in an extension position.

FIG. 2 is a perspective view of one embodiment of a piston assembly incorporating the subject invention.

FIG. 3 is a perspective view of another embodiment of a piston assembly incorporating the subject invention.

FIG. 4A is a schematic view of a damper assembly with a piston assembly incorporating the subject invention.

FIG. 4B is a schematic view of another damper assembly with a piston assembly incorporating the subject invention.

FIG. 4C is a schematic view of a gas spring assembly with a piston assembly incorporating the subject invention.

### DETAILED DESCRIPTION OF THE PREFERRED EMBODIMENT

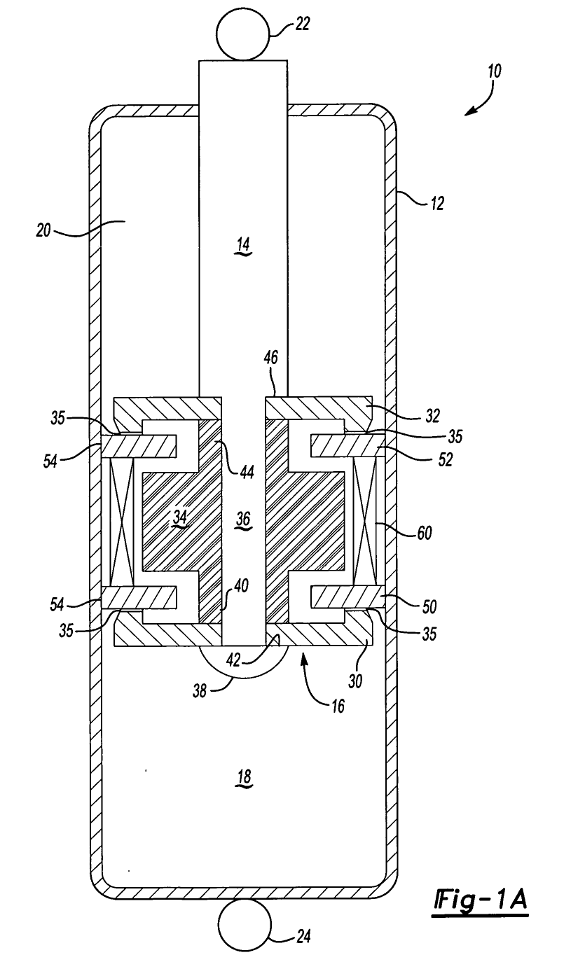

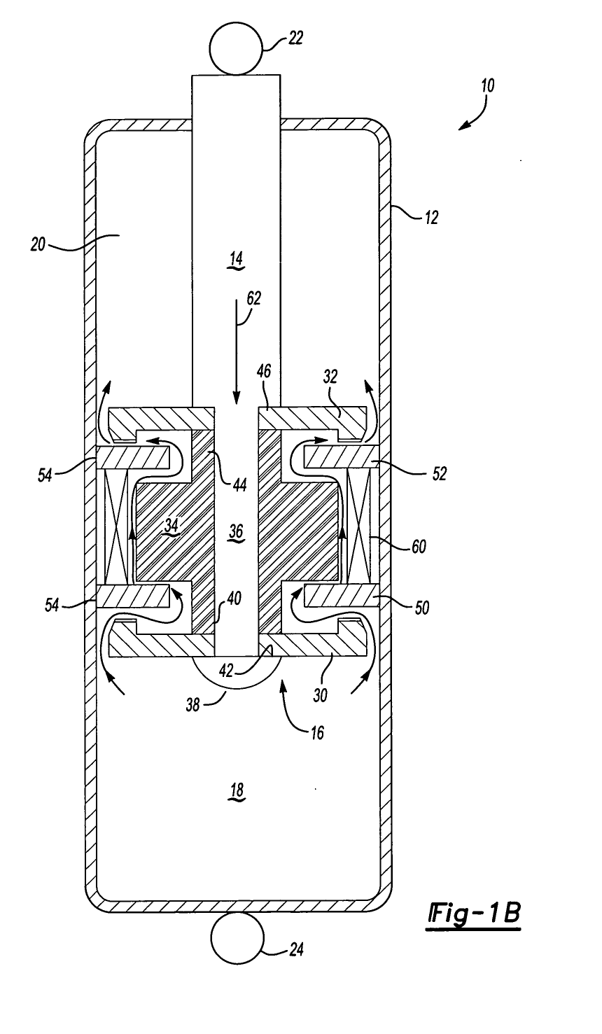

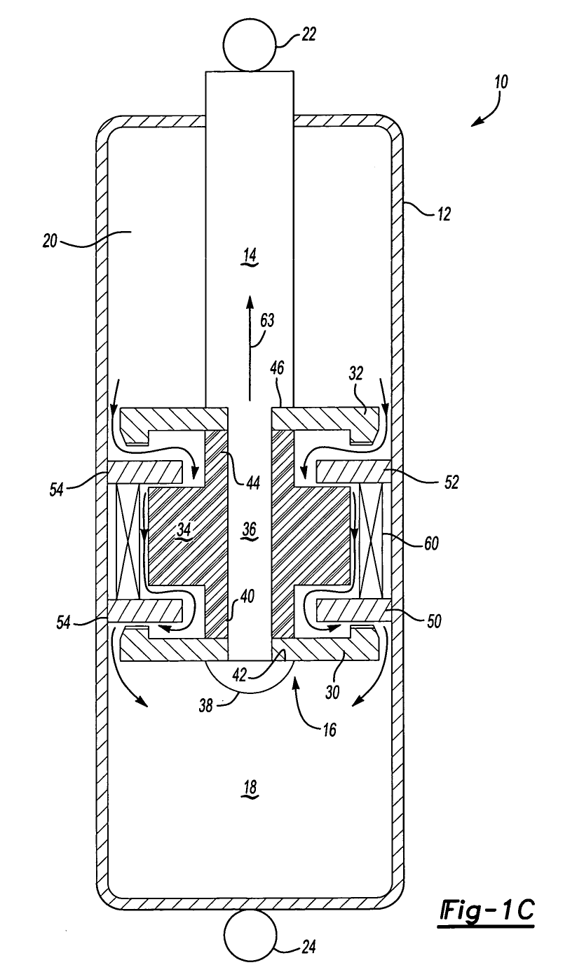

FIG. 1A shows a damper or gas spring assembly 10 including a tube or cylinder 12 and a rod 14 that extends outwardly from the cylinder 12. The rod 14 moves between a fully extended position and a fully compressed position. The rod 14 is connected to a piston assembly 16 that is received within the cylinder 12. The piston assembly 16 separates an inner cavity of the cylinder 12 into a compression chamber 18 and a rebound or extension chamber 20. The piston assembly 16 is moved axially by the rod 14 to control fluid flow between the compression 18 and extension 20 chambers as the rod 14 moves between the fully extended and fully compressed positions as known.

The damper or gas spring assembly 10 is typically used to control movement between a fixed member and a movable member. A first connector 22 is attached to the rod 14 and a second connector 24 is attached to the cylinder 12. One of the first 22 and second 24 connectors is connected to one of the fixed member and movable member. The other of the first 22 and second 24 connectors is connected to the other of the fixed member and the movable member.

The piston assembly 16 includes a first orifice plate 30 and a second orifice plate 32 that are separated from each other by a spacer 34. Each of the first 30 and second 32 orifice plates includes at least one orifice hole 35, schematically shown, to facilitate fluid flow as needed. In the example shown the orifice holes 35 are formed at side surface of the first 30 and second 32 orifice plates, however, the shape, configuration, and location of the orifice holes 35 can vary depending on specific applications. The subject piston assembly 16 can be used with any configuration of orifice holes 35. The spacer 34 is mounted on a reduced diameter portion 36 of the rod 14. A rivet 38 is used to secure and hold the first orifice plate 30, second orifice plate 32, and spacer 34 together on the rod. The rivet 38 can be integrally formed with the rod 14 or can be installed as a separate piece.

One end 40 of the spacer 34 holds the first orifice plate 30 against an end face 42 of the rivet 38. An opposite end 44 of the spacer 34 holds the second orifice plate 32 against a shoulder portion 46 of the rod 14. The spacer 34 maintains a fixed distance between the first 30 and second 32 orifice plates.

A first ring 50 is positioned adjacent the first orifice plate 30. A second ring 52 is positioned adjacent the second orifice plate 32. Both the first 50 and second 52 rings are positioned axially between the first 30 and second 32 orifice plates. The first 50 and second 52 rings are formed as solid bands of a low-friction material, such as polytetrafluoroethylene (PTFE) or Teflon®, for example. One example of this type of ring is a Rulon® ring.

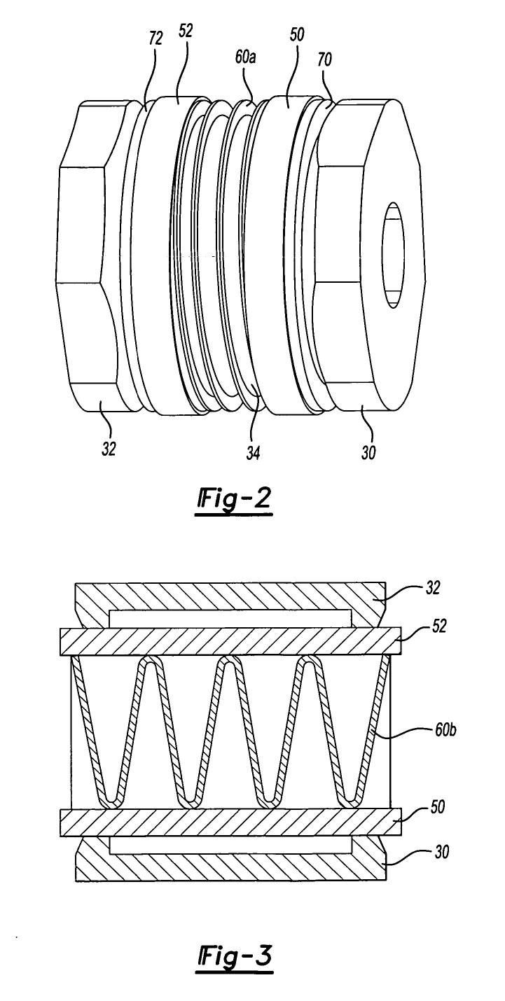

The first 50 and second 52 rings each include an outer peripheral edge 54 that is in abutting, sliding contact with an inner wall surface 56 of the cylinder 12. A resilient member 60, shown schematically in FIGS. 1A-1C, reacts between the first 50 and second 52 rings. The resilient member 60 can comprise a coil spring 60a as shown in FIG. 2 or could comprise a wave spring 60b as shown in FIG. 3, for example.

FIG. 1A shows the piston assembly 16 in a neutral or no load position. During compression movement of the piston assembly 16 in a first direction toward the fully compressed position (indicated by arrow 62 in FIG. 1B), fluid flow forces the first ring 50 away from the first orifice plate 30 and the resilient member 60 resiliently biases the second ring 52 against the second orifice plate 32. During extension movement of the piston assembly 16 in a second direction toward the fully extended position (indicated by arrow 63 in FIG. 1C), fluid flow forces the second ring 52 away from the second orifice plate 32 and the resilient member 60 resiliently biases the first ring 50 against the first orifice plate 30. Thus, due to the low friction material used to form the first 50 and second 52 rings, in combination with the resilient member 60 reacting between the first 50 and second 52 rings, a dead-band area of operation is eliminated during changeovers between extension and compression movement. This provides for a more efficient and effective operation of the damper or gas spring assembly 10.

Optionally, the piston assembly 16 could also include first 70 and second 72 washers positioned between the first 30 and second 32 orifice plates, as shown in FIG. 2. The first washer 70 is positioned directly between the first ring 50 and the first orifice plate 30, and the second washer 72 is positioned directly between the second ring 52 and the second orifice plate 32.

During compression, the first washer 70 and first ring 50 are forced away from the first orifice plate 30 producing a non-restrictive flow path on the rivet side. On the opposite side of the resilient member 60, the second ring 52 and second washer 72 are forced against the second orifice plate 32 producing a restricted flow path through the second orifice plate 32.

The piston assembly 16 could be utilized in various different applications to reduce shuttling of piston components including gas springs, dampers, shock absorbers, etc. Further, the piston assembly 16 could also be used in a hydraulic cylinder or fluid flow application to reduce free play.

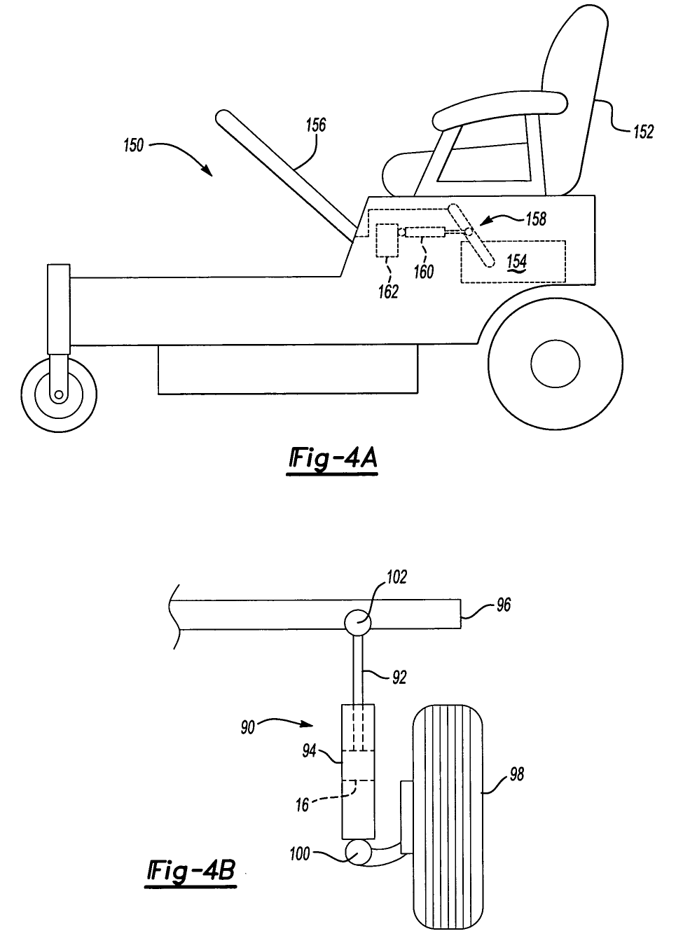

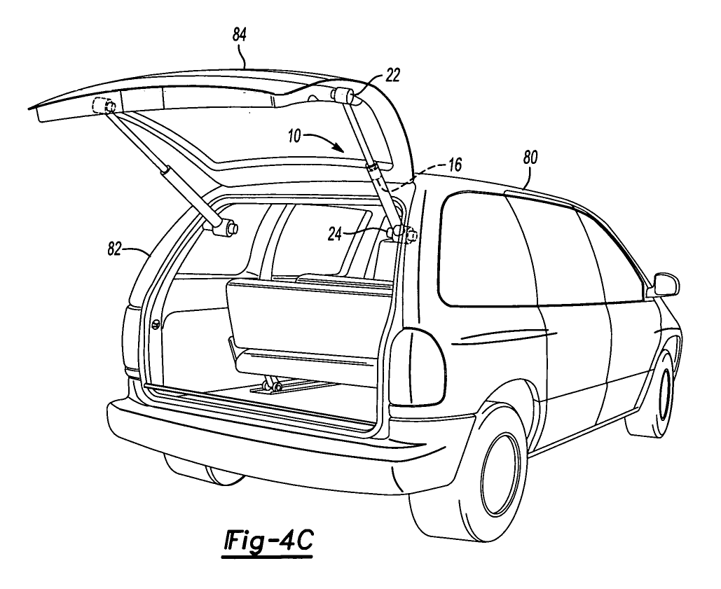

Preferably, the piston assembly 16 is used in a damper application for a lawn mower 150 shown in FIG. 4A. The lawn mower 150 includes a seat 152 that is positioned over a hydrostatic transmission 154. An operator (not shown) operates a shift lever 156 that is coupled to the hydrostatic transmission 154 via a linkage assembly 158. A damper 160, which operates in the manner described above, is installed between the linkage assembly 158 and a frame 162. The damper 160 is shown as being coupled to the linkage assembly 158, however the damper 160 could also be mounted between the shift lever 156 itself and the frame 162. The piston assembly 16 operates to eliminate the dead-band operation area normally caused by shuttling of internal piston components.

The piston assembly 16 could also be used in a damper assembly 90 as shown in FIG. 4B. The piston assembly 16 is connected to a rod 92 and received within a tube 94. The damper assembly 90 is mounted between a fixed vehicle member 96, such as a vehicle frame for example, and a vehicle wheel 98. The damper assembly 90, such as a shock absorber, is used to dampen road load inputs to a vehicle as known. The damper assembly 90 includes first 100 and second 102 connectors. One of the first 100 and second 102 connectors is attached to the rod 92 and the other of the first 100 and second 102 connectors is attached to the tube 94. One of the first 100 and second 102 connectors is attached to one of the fixed vehicle member 96 and vehicle wheel 98 and the other of the first 100 and second 102 connectors is attached to the other of the fixed vehicle member 96 and vehicle wheel 98.

The piston assembly 16 can also be used in a gas spring in a vehicle 80 as shown in FIG. 4C. The gas spring assembly 10 is used in the vehicle 80 to assist movement between a fixed vehicle member 82 and a movable vehicle member 84 that moves relative to the fixed vehicle member 82. The movable vehicle member 84 could comprise a liftgate as shown; however, the movable vehicle member 84 could also be a trunk lid, hood, tailgate, etc. One of the first 22 and second 24 connectors is attached to one of the fixed 82 and movable 84 vehicle members and the other of the first 22 and second 24 connectors is attached to the other of the fixed 82 and movable 84 vehicle members.

It should be understood that while the piston assembly 16 of FIG. 2 includes the first 70 and second 72 washers with the first 50 and second 52 rings and resilient member 60, the piston assembly 16 could operate with only the first 50 and second 52 rings and resilient member 60. Further, the examples shown in FIGS. 1 and 3 could also use first 70 and second 72 washers.

In either configuration, i.e. with or without the first 70 and second 72 washers, the resilient member 60 forces one of the first 50 and second 52 rings against a respective one of the first 30 and second 32 orifice plates (depending upon direction of movement). By forcing the rings against the orifice plates, a dead-band operation area normally caused by shuttling of internal piston components is eliminated.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A piston assembly comprising:
a first orifice plate;
a second orifice plate axially spaced apart from said first orifice plate;
a first ring positioned adjacent said first orifice plate;
a second ring positioned adjacent said second orifice plate wherein both said first and said second rings are positioned axially between said first and second orifice plates; and
a resilient member reacting between said first and second rings to provide a biasing force between said first and second rings.

2. The piston assembly according to claim 1 including a spacer adapted to be fixed to a rod wherein said first and second orifices plates are held at a fixed distance apart from each other by said spacer.

3. The piston assembly according to claim 1 wherein said resilient member comprises a coil spring.

4. The piston assembly according to claim 1 wherein said resilient member comprises a wave spring.

5. The piston assembly according to claim 1 including a first washer positioned between said first ring and said first orifice plate and a second washer positioned between said second ring and said second orifice plate.

6. The piston assembly according to claim 1 wherein said first and second rings are comprised of solid bands of polytetrafluoroethylene (PTFE) material.

7. A piston and cylinder assembly comprising:
a cylinder defining an inner cavity;
a piston mounted within said cylinder to separate said inner cavity in to a compression side and a rebound side;
a rod having a first rod end coupled to said piston to move said piston within said cylinder between a fully compressed position and a fully extended position; and
wherein said piston comprises a first orifice plate positioned adjacent said compression side, a second orifice plate positioned adjacent said rebound side and axially spaced apart from said first orifice plate, a first ring positioned for abutting engagement with said first orifice plate and a second ring positioned for abutting engagement with said second orifice plate, said first and second rings being positioned axially between said first and second orifice plates, and a resilient member reacting directly between said first and second rings.

8. The piston and cylinder assembly according to claim 7 wherein during compression movement of said piston in a first direction toward said fully compressed position, fluid flow forces said first ring away from said first orifice plate and said resilient member resiliently biases said second ring against said second orifice plate, and wherein during extension movement of said piston in a second direction toward said fully extended position, fluid flow forces said second ring away from said second orifice plate and said resilient member resiliently biases said first ring against said first orifice plate.

9. The piston and cylinder assembly according to claim 7 wherein said resilient member immediately transfers movement from one of said first and second rings directly to the other of said first and second rings during movement of said piston between fully compressed and fully extended positions.

10. The piston and cylinder assembly according to claim 9 wherein said resilient member has an outer diameter that is less than an outer diameter of said first and second rings.

11. The piston and cylinder assembly according to claim 7 wherein said first and second rings have an outer peripheral surface that is in direct abutting contact with an inner wall surface of said cylinder.

12. The piston and cylinder assembly according to claim 11 wherein said first and second rings are formed as solid bands of polytetrafluoroethylene (PTFE) material to provide a low-friction interface between said cylinder and said piston.

13. The piston and cylinder assembly according to claim 7 wherein said resilient member comprises a coil spring.

14. The piston and cylinder assembly according to claim 7 wherein said resilient member comprises a wave spring.

15. The piston and cylinder assembly according to claim 7 including a first washer positioned between said first ring and said first orifice plate and a second washer positioned between said second ring and said second orifice plate.

16. The piston and cylinder assembly according to claim 7 including a spacer fixed to said rod wherein said first and said second orifices plates are held at a fixed distance apart from each other by said spacer.

17. A vehicle component assembly comprising:
a fixed vehicle member;
a movable vehicle member movable relative to said fixed vehicle member; and
a tube and piston assembly including a first orifice plate, a second orifice plate axially spaced apart from said first orifice plate, a first ring positioned adjacent said first orifice plate, a second ring positioned adjacent said second orifice plate wherein both said first and said second rings are positioned axially between said first and second orifice plates, and a resilient member reacting between said first and second rings to provide a biasing force between said first and second rings wherein said tube and piston assembly cooperate to control movement between said fixed vehicle member and said movable vehicle member.

18. The vehicle component assembly according to claim 17 wherein said tube and piston assembly comprise a damper with said fixed vehicle member comprising a vehicle frame and said movable vehicle member comprising a linkage assembly.

19. The vehicle component assembly according to claim 17 wherein said tube and piston assembly comprise a gas spring assembly with said movable vehicle member comprising a vehicle body panel.

20. The vehicle component assembly according to claim 17 wherein said first and second rings are formed as solid bands of polytetrafluoroethylene (PTFE) material and said resilient member comprises a spring.
